(19) United States
(12) Patent Application Publication
(10) Pub. No.: US 2019/0208962 A1
(43) Pub. Date: Jul. 11, 2019

(54) SWIZZLE STICK INCLUDING SPACED MIXING BLADES

(71) Applicant: Ronald W. Mortara, Cambridge, MA (US)

(72) Inventor: Ronald W. Mortara, Cambridge, MA (US)

(21) Appl. No.: 16/217,272

(22) Filed: Dec. 12, 2018

Related U.S. Application Data
(60) Provisional application No. 62/613,832, filed on Jan. 5, 2018.

(51) Int. Cl. A47J 43/27

(52) U.S. Cl. CPC A47J 43/27; B01F 13/002

(57) ABSTRACT

A swizzle stick or drink stirring device includes an elongated member having a first end and a second end and at least one pair of opposed mixing blade segments extending outward from the elongated member and adjacent the second end. Plural opposed pairs of mixing blade segments may be spaced from one another near the lower end of the elongated member. Each opposed pair of mixing blade segments has a common axis that is generally perpendicular to a longitudinal axis of the elongated member. The mixing blade segments have a distal end that terminates in a generally loop-like or paddle-shaped end.

This patent application claims priority from U.S. Provisional Patent Application No. 62/613,832, filed Jan. 5, 2018, the disclosure of which is incorporated by reference herein in its entirety.

### STATEMENT REGARDING FEDERALLY SPONSORED RESEARCH OR DEVELOPMENT

N/A

### BACKGROUND OF THE INVENTION

Various embodiments relate generally to a swizzle stick and, more specifically, relate to a swizzle stick having a plurality of opposed mixing blade segments that terminate in loop-like or paddle-like ends.

This section is intended to provide a background or context. The description may include concepts that may be pursued, but have not necessarily been previously conceived or pursued. Unless indicated otherwise, what is described in this section is not deemed prior art to the description and claims and is not admitted to be prior art by inclusion in this section.

Swizzle sticks have been long used for the mixing of drinks, including mixed drinks containing alcoholic beverages. It is reported that swizzle sticks were originally created during the 18^{th} century on a rum plantation in the West Indies. The original swizzle sticks were obtained from a branch of a plant. A branch having a plurality of finger-like members that extended from one end of the stick was cut from the plant to obtain the swizzle stick. Since the original swizzle sticks were branches of plants, a suitable branch would need to located, cut, and shaved by hand, to form an article that was appropriate for its intended purpose. The fashioning of swizzle sticks from plants was and remains labor intensive and is not consistent with the production of such articles for high volume distribution.

Some attempts have been made to adapt swizzle stick production for modern production methods. Typically, alternatives to the original swizzle stick have employed two or more dowels mounted to the end of a stick. Dowels, however, provide little surface area and are relatively ineffective for mixing crushed ice with drink contents to rapidly cool the contents.

Accordingly, it would be desirable to have a more effective alternative to the original swizzle stick and those employing dowels of generally circular cross-section for mixing of drinks including crushed ice. Additionally, it would be desirable for a swizzle stick construction to be suitable for manufacture via high volume production techniques.

### BRIEF SUMMARY OF THE INVENTION

The below summary is merely representative and non-limiting.

The above problems are overcome, and other advantages may be realized, by the use of the embodiments.

In a first aspect, an embodiment provides a swizzle stick or drink stirrer for stirring mixed drinks. The swizzle stick includes an elongated member having a length that extends from an upper first end to a lower second end. At least one pair of mixing blade segments extends from opposing sides of the lower end of the elongated member. Plural opposed pairs of mixing blade segments may be employed. When plural opposed pairs of mixing blade segments are employed, each mixing blade segment pair has a common axis and the opposing pairs of mixing blade segments are spaced from one another along the lower portion of the elongated member. Distal ends of the respective blade segments terminate in loop-like or paddle-like members or other geometric shapes to facilitate mixing of drink contents upon twirling of the swizzle stick. During use, the lower end of the elongated member and the mixing blade segments are inserted into a drink that typically contains crushed ice and the swizzle stick is twirled to rapidly cool the liquid drink contents.

### BRIEF DESCRIPTION OF THE SEVERAL VIEWS OF THE DRAWINGS

Aspects of the described embodiments are more evident in the following description, when read in conjunction with the attached Figures.

FIG. 1a is a perspective view of a first embodiment of a swizzle stick having two mixing blades;

FIG. 1b is a top view of the swizzle stick of FIG. 1a;

FIG. 1c is a front elevation view of the swizzle stick of FIG. 1a, the rear elevation view being a mirror of the front elevation view;

FIG. 1d is a side elevation view of the right and left sides of the swizzle stick of FIG. 1a;

FIG. 1e is a bottom view of the swizzle stick of FIG. 1a;

FIG. 1f is a front elevation view of a first embodiment of a mixing blade segment depicting a mixing blade paddle having an opening therethrough;

FIG. 1g is a front elevation view of a second embodiment of a mixing blade segment depicting a mixing blade paddle without an opening therethrough;

FIG. 2a is a perspective view of a second embodiment of a swizzle stick having three mixing blades;

FIG. 2b is a top view of a swizzle stick of FIG. 2a;

FIG. 2c is a front elevation view of the swizzle stick of FIG. 2a, the rear elevation view being the same as the front elevation view;

FIG. 2d is a side elevation view of the right and left sides of the swizzle stick of FIG. 2a;

FIG. 2e is a bottom view of the swizzle stick of FIG. 2a;

FIG. 3a is a front elevation view of a third embodiment of a swizzle stick, which is the same as the rear elevation view;

FIG. 3b is a right side elevation view of the third embodiment of FIG. 3a, which is the same as the left side elevation view;

FIG. 4a is a front elevation view of a fourth embodiment of a swizzle stick, which is the same as the rear elevation view;

FIG. 4b is a right side elevation view of the fourth embodiment of FIG. 3a, which is the same as the left side elevation view;

FIG. 5a is a perspective view of a fifth embodiment of a swizzle stick having three mixing blades;

FIG. 5b is a top view of a swizzle stick of FIG. 5a;

FIG. 5c is a front elevation view of the swizzle stick of FIG. 5a, the rear elevation view being the same as the front elevation view;

FIG. 5d is a side elevation view of the right and left sides of the swizzle stick of FIG. 5a;

FIG. 5e is a bottom view of the swizzle stick of FIG. 5a;

FIG. 6a is a top view of a sixth embodiment of a swizzle stick having round paddle members;

FIG. 6b is a front elevation view of the swizzle stick of FIG. 6a, the rear elevation view being the same as the front elevation view;

FIG. 6c is a side elevation view of the right and left sides of the swizzle stick of FIG. 6a;

FIG. 6d is a bottom view of the swizzle stick of FIG. 6a;

FIG. 7a is a top view of a seventh embodiment of a swizzle stick having rectangular paddle members;

FIG. 7b is a front elevation view of the swizzle stick of FIG. 7a, the rear elevation view being the same as the front elevation view;

FIG. 7c is a side elevation view of the right and left sides of the swizzle stick of FIG. 7a;

FIG. 7d is a bottom view of the swizzle stick of FIG. 7a;

FIG. 8a is a top view of an eighth embodiment of a swizzle stick having extended, round paddle members;

FIG. 8b is a front elevation view of the swizzle stick of FIG. 8a, the rear elevation view being the same as the front elevation view;

FIG. 8c is a side elevation view of the right and left sides of the swizzle stick of FIG. 8a;

FIG. 8d is a bottom view of the swizzle stick of FIG. 8a;

FIG. 9a is a top view of a ninth embodiment of a swizzle stick having extended, rectangular paddle members;

FIG. 9b is a front elevation view of the swizzle stick of FIG. 9a, the rear elevation view being the same as the front elevation view;

FIG. 9c is a side elevation view of the right and left sides of the swizzle stick of FIG. 9a; and

FIG. 9d is a bottom view of the swizzle stick of FIG. 9a.

### DETAILED DESCRIPTION OF THE INVENTION

Exemplary embodiments are described by way of example with reference to the accompanying figures. The same reference numbers appearing in the various figures are intended to refer to the same component or element. For purposes of clarity, every component or element may not be labeled in every figure, nor is every component of each embodiment shown where illustration is not necessary.

In the following description, specific details are set forth in order to provide a thorough understanding of the embodiments. It will be understood by those of ordinary skill in the art that these embodiments may be practiced without some of the specific details described herein. In other instances, well-known methods, procedures, components, and structures may not have been described in detail so as not to obscure the embodiments and methods employed in accordance with the present invention although the use of such well-known methods, procedures, components, and structures will be understood by those of ordinary skill in the art.

Prior to explaining at least one embodiment in detail, it is to be understood that the invention is not limited in its application to the details of construction and the arrangement of the components set forth in the following description or as illustrated in the drawings. The invention is capable of other embodiments or of being practiced or carried out in various ways. Also, it is to be understood that the phraseology and terminology employed herein are for the purpose of description and should not be regarded as limiting.

It is appreciated that certain features which are, for clarity, described in the context of separate embodiments, may also be provided in combination in a single embodiment or with other embodiments disclosed herein. Conversely, various features which are, for brevity, described in the context of a single embodiment, may also be provided separately or in any suitable sub-combination.

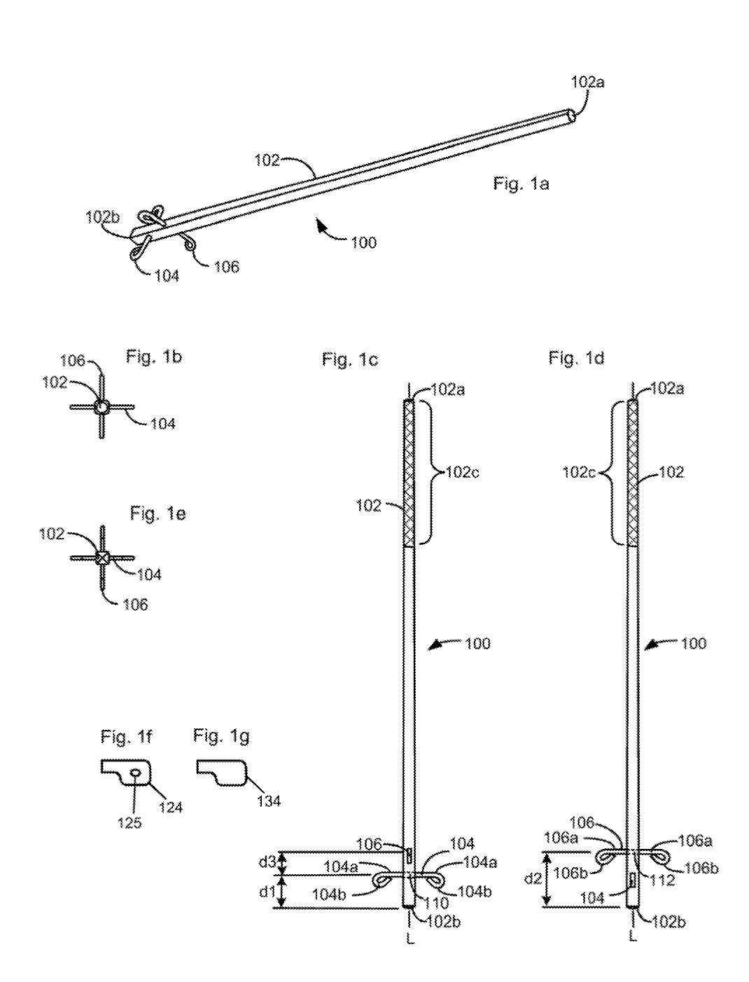

Various embodiments provide a swizzle stick and methods for producing a swizzle stick for use in mixing of mixed drinks. FIGS. 1a-1e depict a first embodiment of a swizzle stick 100 that includes two mixing blades 104, 106. More specifically, the swizzle stick 100 includes an elongated member 102 that extends from a first or upper end 102a to a second or lower end 102b. First and second mixing blades 104 and 106 respectively are provided adjacent to the lower end 102b of the elongated member 102 as discussed in greater detail below. In the illustrated embodiment, the elongated member 102 has a generally square cross-section at the lower end 102b and tapers to a generally circular cross-section at the first or upper end 102a of the elongated member 102. In one embodiment, the elongated member 102 is fabricated from a conventional chopstick. Chopsticks are widely commercially available as food-safe wooden and plastic items. The elongated member 102 may have any other suitable cross-section. By way of non-limiting examples, the cross-section of the lower portion of the elongated member 102 may be square, circular, hexagonal or octagonal and may taper to a generally circular cross-section at the upper end of the elongated member 102 or alternatively have the same cross-section along the length of the elongated member 102. Additionally, if the elongated member 102 has the same cross-section along its length, the cross-section may have the same dimensions along its length or alternatively be tapered from the lower end 102b to the upper end 102a.

In one embodiment of the swizzle stick 100, through-holes 110, 112 are provided in the elongated member 102 adjacent the lower end 102b. As illustrated in FIG. 1c, a first through-hole 110 through the elongated member 102 is provided a distance d1 from the lower end 102b and, as illustrated in FIG. 1d, a second through-hole 112 is provided through the elongated member 102 at a distance d2 from the lower end 102b. The distance d2 is greater than the distance d1 by a spacing d3 as depicted in FIG. 1c and FIG. 1d. The elongated member 102 has a longitudinal axis L along its length. In the illustrated embodiment, the through-holes 110, 112 are generally perpendicular to the longitudinal axis L and are also perpendicular to each other.

First and second mixing blades 104, 106 extend through the first and second through-holes 110, 112. The mixing blades are formed of a food-safe material, such as a food-safe metal, a food-safe plastic or a food-safe composite and have a diameter sized for an interference fit with the through-holes 110, 112 so as to be securely retained within the through-holes 110, 112 when disposed therein. The mixing blades 104, 106 are mounted within the through-holes 110, 112 by urging the blades 104, 106 through the respective through-holes 110, 112 so as to provide mixing blade segments 104a of generally equal length on opposing sides of the elongated member 102 and mixing blade segments 106a of generally equal length on opposing sides of the elongated member 102. The mixing blade segments 106a are oriented so as to be perpendicular to the mixing blade segments 104a due to the perpendicular orientation of the through-holes 110, 112. In the illustrated embodiment, ends of the mixing blade segments 104a, 106a terminate in loops 104b, 106b as illustrated in FIGS. 1c and 1d. The loops 104b, 106b may be formed at the ends of the mixing blade segments 104a, 106a via known bending or forming techniques. For example, if the mixing blades 104, 106 are aluminum, the ends of the mixing blade segments 104a, 106a may be bent or formed using conventional metal forming techniques to provide the desired loop-like ends 104b, 106b. If the mixing blades 104, 106 are plastic, the loop-like ends 104b, 106b may be formed using conventional heat forming techniques.

To facilitate twirling of the swizzle stick 100 while avoiding slippage, a portion 102c of the elongated member 102 adjacent the upper end 102a may be provided with a roughened or knurled surface since a user's hands may be wet and a smooth surface for the elongated member 102 may be slippery in the absence of such a textured surface.

The elongated member 102 may have any desired length convenient for a mixologist's use. By way of example, and not limitation, the elongated member may have a length in the range between 6 and 16 inches, between 8 and 12 inches, between 9¾ and 11¾ inches or any other suitable length. In one embodiment, the lower portion of the elongated member 102 has a generally square cross section of approximately ¼ inch on each side. It should be recognized that the dimensions of the cross-section of the elongated member may vary.

In the illustrated embodiment, the mixing blades 104, 106 are depicted as being of substantially the same length. In an alternative embodiment, the mixing blades may be of different lengths. By way of example, in one embodiment the mixing blade 106 may be longer than the mixing blade 104 to provide a stepped appearance in which the upper mixing blade 106 has mixing blade segments 106a that are longer than the lower mixing blade segments 104a. Alternatively, the lower mixing blades 104 may be longer than the upper mixing blades 106 such that the mixing blade segments 104a are longer than the mixing blade segments 106a.

While FIGS. 1a-1e depict a swizzle stick 100 having two mixing blades 104, 106, one or more mixing blades of the type disclosed herein may be employed. Moreover, one, two, three, four or more opposing pairs of mixing blade segments may be provided which are distinct mixing blade segments that are attached to the elongated member 102 or formed as an integral, continuous one-piece article with the elongated member 102 as subsequently discussed. When plural pairs of mixing blades or opposed mixing blade segment pairs are employed, they are spaced along a length of the lower portion of the elongated member 102.

Additionally, while the illustrated embodiment depicts mixing blades that are oriented so as to be perpendicular to one another, when plural mixing blades are employed, the mixing blades may be oriented at different angles with respect to each other. For example, with an elongated member having a hexagonal cross-section, three mixing blades may be spaced along the lower portion of the elongated member 102 and angled with respect to adjacent mixing blades by 60 degrees. Similarly, with an elongated member having an octagonal cross-section, four mixing blades may be provided in spaced relation along the lower portion of the elongated member 102 and angled with respect to one another by 45 degrees. Alternatively, the opposing pairs of mixing blade segments may be oriented at other angles with respect to other opposing pairs of mixing blade segments. Mixing blades may be angled with respect to each other at any of the foregoing angles or at any other desired angles when using an elongated member of generally circular cross-section. In another embodiment, all opposed pairs of mixing blade segments may be aligned in a common plane.

Furthermore, the mixing blade segments may define a plane that contains the axis of the elongated member, such as shown. However, in other, non-limiting embodiments, the mixing blade segments may be turned so as to create an angle of 45 degrees with the elongated member. The paired mixing blade segments define a single plane or each mixing blade segment may define an associated plane which is at an angle to the associated plane of the other mixing blade segment, for example, one mixing blade segment may be at an angle of 45 degrees to the elongated member and the other mixing blade segment may be at an angle of −45 degrees to the elongated member.

Since the swizzle stick 100 is intended for the mixing of crushed ice with consumable liquids, including mixed drinks containing alcohol, the elongated member and the mixing blades are formed of food-safe materials. By way of example, and not limitation, the elongated member and the mixing blades and/or mixing blade segments may be formed of a food-safe wood, a food safe metal, such as aluminum or stainless steel, a food-safe plastic such as PETE (polyethylene terephthalate), HDPE (high density polyethylene), LDPE (low density polyethylene), PP (polypropylene), melamine or other food-safe composites or materials.

While the above-described swizzle stick is formed with mixing blades or mixing blade segments that are mounted to the elongated member, the elongated member and one or more pairs of opposing mixing blade segments may be formed as a single, continuous, integrally formed article that is cast or molded from any suitable food-safe metal, plastic or composite.

Additionally, while the illustrated embodiment depicts mixing blades 104, 106 that extend through through-holes 110, 112, separate mixing blade segments 104a, 106a may be provided that have proximal portions sized and configured to be inserted partially into through-holes 110, 112 from opposing sides of the elongated member 102 to retain the opposed mixing blade segments 104a, 106a securely within the through-holes 110, 112 of the elongated member 102. Alternatively, proximal portions of the mixing blade segments 104a, 106a may be secured in holes which do not extend all the way through the elongated member 102. A food-safe glue or adhesive may be employed to retain the mixing blade segments 104a, 106a within the holes. Moreover, if both the elongated member 102 and mixing blade segments 104a, 106a are formed of plastic, ultrasonic welding may be employed to securely retain the mixing blade segments 104a, 106a within the through-holes 110, 112.

Irrespective of whether the swizzle stick is formed using mixing blades that are inserted through the through-holes, using distinct mixing blade segments that are inserted into holes in the elongated member from opposite sides of the elongated member or, with mixing blade segments are cast or molded as an integral, continuous one-piece article with the elongated member, the mixing blade segments include a proximal portion that connects the mixing blade segment to the elongated member and a distal end that extends from the proximal portion. The distal ends are formed as integral, continuous, one-piece members with the proximal portions of the mixing blade segments. The proximal portions have a cross-section with a maximum dimension. The distal ends have a width, a height and a thickness. In embodiments such as those including loop-like or paddle ends, at least the width and the height of the distal ends are greater than the maximum cross-section dimension of the proximal portions and the height and width of the distal ends are greater than the thickness of the distal ends. In other embodiments, in which the distal ends have other geometric shapes as subsequently discussed, the width, height and thickness of the distal ends are all greater than the maximum dimension of the cross-section of the proximal portion of the mixing blade segment.

If separate mixing blade segments 104a, 106a are employed, they need not be urged all the way through the through-holes 110, 112 of the elongated member 102. Accordingly, the mixing blade segments 104a, 106a may be machined, formed, cast or molded so as to have the shape of a paddle of a desired cross-section or a distal end configuration with any other suitable geometric shape. For example, mixing blade segments 104a, 106a may be formed, machined, cast or molded of a food-safe metal, plastic or composite as a paddle 124 having an opening 125 therethrough as illustrated in FIG. 1f or, as a paddle 134 without an opening through the distal end as illustrated in FIG. 1g.

Furthermore, while in the illustrated embodiment, the loops 104b, 106b of the mixing blade segments 104a, 106a are illustrated as extending downward below a centerline of the through-holes 110, 112 in the elongated member 102, in an alternative embodiment, some or all of the mixing blade segments 104a, 106a may be oriented such that the mixing blade segment loop-like ends or paddles 104b, 106b extend generally above centerlines of respective through-holes 110, 112 or above a common axis of opposed mixing blade segments 104a, 106a toward the upper end of the elongated member 110, 112. Alternatively, loop-like ends or paddles 104b, 106b at distal ends of the mixing blade segments 104a, 106a may be generally symmetrically disposed with respect to through-holes 110, 112 or a common axis of opposed mixing blade segments 104a, 106a through points of attachment of the opposed mixing blade segments 104a, 106a to the elongated member 102. Thus, loop-like or paddle-like distal ends 104b, 106b of mixing blade segments 104a, 106a may extend generally upward, downward or be located straight outward with respect to a common axis through points of attachment of opposed mixing blade segments 104a, 106a to the elongated member 102.

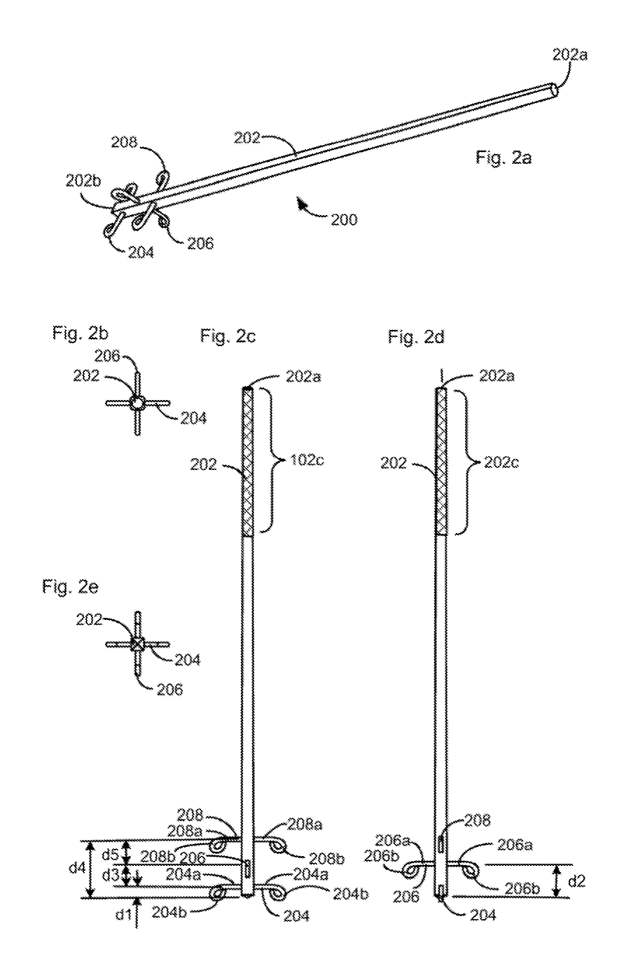

FIGS. 2a-2e illustrate a swizzle stick 200 having an elongated member 202 that includes three through-holes spaced along the lower portion of the elongated member 202 and sized to receive and securely retain three mixing blades 204, 206 and 208 via an interference fit. The mixing blades 204, 206, 208 include opposed mixing blade segments 204a, 206a and 208a that extend from opposite sides of the elongated member 202 as discussed above with respect to the two mixing blade embodiment of FIGS. 1a-1g. In the illustrated embodiment, mixing blade segments 204a, 206a, 208a terminate in loop-like ends or paddles 204b, 206b, 208b to provide effective mixing of crushed ice and drink contents upon twirling of the swizzle stick 200.

The centerline of the lowest through-hole for mixing blade 204 has a centerline that is spaced by a distance d1 from the lower end 202b of the elongated member 202 and the 2^{nd} lowest through-hole for mixing blade 206 has a centerline that is spaced from the lower end of the elongated member 202 by a distance d2 which is greater than the distance d1 by a spacing d3. The centerline of the highest through-hole for mixing blade 208 has a centerline that is spaced by a distance d4 from the lower end 202b of the elongated member which is greater than the distance d2 by a distance d5.

The illustrated embodiments include mixing blade segments having distal ends with loop-like ends or paddles having a width, a height and a thickness. In such embodiments, the width and the height of the distal ends are greater than the thickness of the distal ends. The mixing blade ends thus provide a technological and aesthetically interesting appearance in addition to providing a mixing function. The mixing blade segments may have a proximal portion having a dowel-like cross-section or any other suitable cross-section for attachment or connection to the elongated member. The cross-section of the proximal portion has a maximum dimension. The distal end of the mixing blade segment extends from the proximal portion. In addition to the loop-like or paddle-like distal ends described hereinabove, the distal ends may have a spherical, oval, pyramidal or other geometric shape having a width, height and depth or thickness that are all larger than the maximum cross-section of the proximal portion of the mixing blade segment that attaches or connects to the elongated member. Such structures provide a unique ornamental appearance while providing a mixing function upon twirling of the swizzle stick.

The alternatives discussed above are equally applicable to the three mixing blade embodiment of FIGS. 2a-2e.

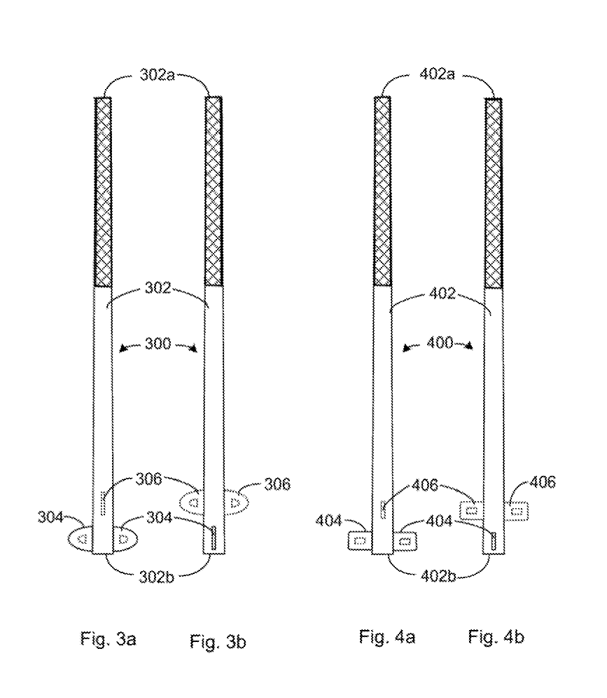

FIGS. 3a and 3b depict a third embodiment of a swizzle stick 300 that includes an elongated member 302 that extends from an upper end 302a to a lower end 302b. The swizzle stick 300 further includes paddles member 304 adjacent the lower end 302b of the elongated member 302. Additionally, the swizzle stick 300 may optionally include one or more additional levels of paddle members 306 spaced above the paddle members 304. The paddle members 304, 306 may be attached to the elongated member 302 via dowel like members that extend into holes in the elongated member 302. Alternatively, the paddle members 304, 306 may be cast or molded as an integral, continuous, one-piece article with the elongated member 302. A side of the paddle members having a maximum paddle member height is directly adjacent the elongated member 302 where the paddle members 304, 306 meet the sides of the elongated member 302. As illustrated, the paddle members 304, 306 are generally semicircular or a portion of an oval. When plural opposed pairs of paddle members 304, 306 are employed, the adjacent paddle member rows may be angled with respect to one another as depicted in FIGS. 3a and 3b in which the paddle members 306 have a common axis that is perpendicular to a common axis through the paddle members 304.

FIGS. 4a and 4b depict a fourth embodiment of a swizzle stick 400 that includes an elongated member 402 that extends from an upper end 402a to a lower end 402b and also includes paddle members 404, 406. The swizzle stick 400 is generally the same as the swizzle stick 300 noting that the paddle members 404, 406 are generally rectangular rather than semicircular. Other paddle member shapes may be employed.

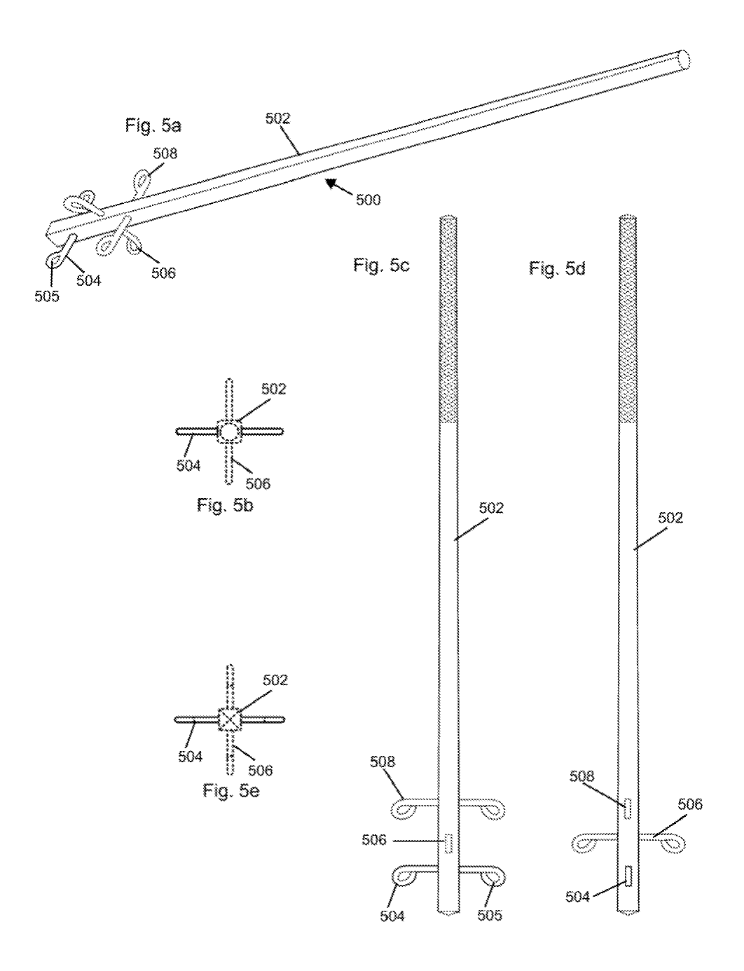

Mixing blade segments having a loop-like shape may be formed or shaped of plastic, round metal bar stock, square metal bar stock, e.g. aluminum bar stock or any other food safe metal, or cast or molded as an integral, continuous one-piece article with the elongated member as depicted in other embodiments illustrated in FIGS. 5-9. If not cast or molded, the mixing blade segments may have proximal portions inserted within holes in the elongated member as previously discussed or attached via any other suitable attachment technique known in the art. Where outer edges of mixing blade segments as shown in dashed lines, such indicates that the mixing blade segments are optional. Where dashed lines are shown within a mixing blade segment in solid lines, such includes that the opening defined by the dashed lines is optional; i.e., if the opening is removed, the mixing blade segment has the form of a solid paddle member. Where mixing blade segments are shown with outer edges in dashed lines and an inner form also shown in dashed lines, such indicates that the mixing blade segment is optional, and, if the mixing blade segment is present, it may include an opening therethrough, or be provided as a paddle member without an opening therethrough. The upper portion of the swizzle sticks depicted in dashed lines in FIGS. 5-9 illustrate an optional roughened or knurled surface to minimize slippage during handling or twirling of the swizzle stick.

FIGS. 5a-5e illustrate a swizzle stick 500 having an elongated member 502 that includes paddles members 504 adjacent the lower end of the elongated member 502. Additionally, the swizzle stick 500 may optionally include one or more additional levels of paddle members 506, 508 spaced above the paddle members 504. The paddle members 504, 506, 508 may include holes 505 in the mixing blade segments.

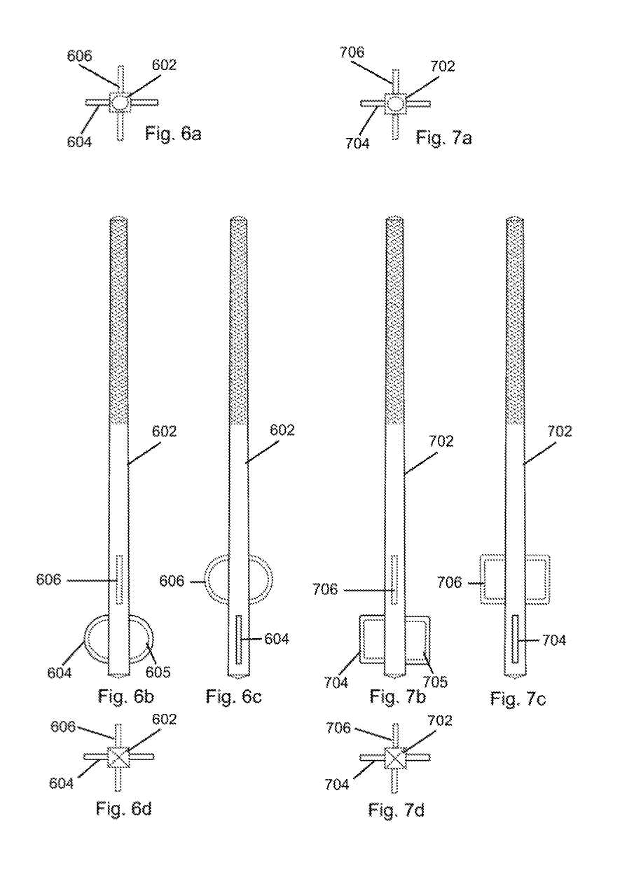

FIGS. 6a-6d illustrate a swizzle stick 600 having an elongated member 602 that includes round or semi-circular paddles members 604 adjacent the lower end of the elongated member 602. Additionally, the swizzle stick 600 may optionally include an additional levels of semi-circular paddle members 606 spaced above the paddle members 604. The paddle members 604, 606 may include holes 605 in the mixing blade segments.

FIGS. 7a-7d illustrate a swizzle stick 700 having an elongated member 702 that includes rectangular paddles members 704 adjacent the lower end of the elongated member 702. Additionally, the swizzle stick 700 may optionally include an additional levels of rectangular paddle members 706 spaced above the paddle members 704. The paddle members 704, 706 may include holes 705 in the mixing blade segments.

Various embodiments provide paddles or mixing surfaces which are held away from the sides of the swizzle stick. These embodiments may allow the swizzle stick to more effectively stir the mixture by allowing the ice to move around the paddles as the stick is rotated.

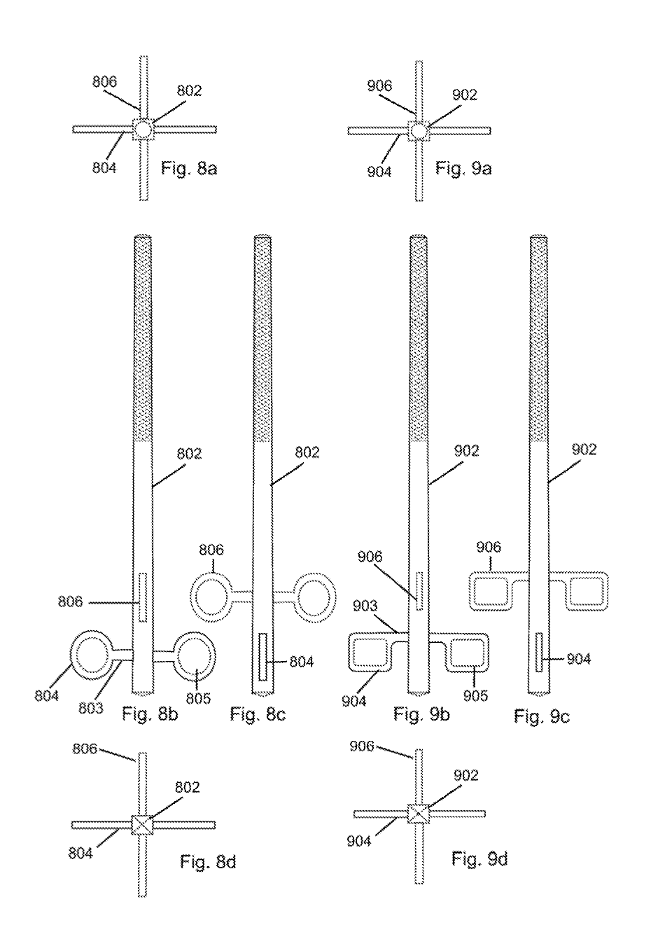

FIGS. 8a-8d illustrate a swizzle stick 800 having an elongated member 802 that includes round or semi-circular paddles members 804 held away from the elongated member 602 by extension 803. Additionally, the swizzle stick 800 may optionally include an additional levels of semi-circular paddle members 806 spaced above the paddle members 804. The paddle members 804, 806 may include holes 805 in the mixing blade segments.

FIGS. 9a-9d illustrate a swizzle stick 900 having an elongated member 902 that includes rectangular paddles members 904 held away from the elongated member 902 by extension 903. Additionally, the swizzle stick 900 may optionally include an additional levels of rectangular paddle members 906 spaced above the paddle members 904. The paddle members 904, 906 may include holes 905 in the mixing blade segments.

It should be understood by those of ordinary skill that variations of and modifications to the above described swizzle stick embodiments and methods of making the same may be made without departing from the inventive concepts disclosed herein. Accordingly, the invention is not to be viewed as limited except by the scope and spirit of the appended claims.

What is claimed is:

1. A drink stirring device comprising:
an elongated member having a first end, a second end, opposing sides and a longitudinal axis; and
at least one pair of mixing blade segments extending from the opposing sides of the elongated member adjacent the second end, wherein each mixing blade segment includes a proximal portion and a distal end, the proximal portion coupling the respective mixing blade segment to the elongated member and having a cross-section with a maximum dimension, the distal end having a height, a width and a thickness, wherein at least the height and the width of the distal end are greater than the maximum dimension of the proximal portion of the mixing blade segment.

2. The drink stirring device of claim 1, wherein the elongated member includes a textured surface adjacent to the first end.

3. The drink stirring device of claim 2, wherein the textured surface comprises at least one of: a roughened surface and a knurled surface.

4. The drink stirring device of claim 1, wherein each of the at least one pair of mixing blade segments defines an opening within the mixing blade segment.

5. The drink stirring device of claim 1, wherein the at least one pair of mixing blade segments have one of: a generally rounded shape and a generally rectangular shape.

6. The drink stirring device of claim 1, wherein the proximal portion of each of the at least one pair of mixing blade segments includes a first portion of a metal bar stock.

7. The drink stirring device of claim 6, wherein the distal portion of each of the at least one pair of mixing blade segments includes a second, shaped portion of the metal bar stock.

8. The drink stirring device of claim 7, wherein the second, shaped portion of the metal bar stock comprises a loop of the metal bar stock.

9. A drink stirring device comprising:
an elongated member defining a longitudinal axis; and
at least one pair of mixing blade segments extending from the elongated member at a location proximal to a lower end of the elongated member,
wherein each mixing blade segment includes a proximal portion adjacent to the elongated member and a distal end distant from the elongated member, the proximal portion coupling the respective mixing blade segment to the elongated member,
wherein the proximal portion has a proximal portion cross-section with a maximum, proximal portion dimension,
wherein the distal end has a distal portion cross-section with a maximum, distal portion dimension, and
wherein at least the maximum, distal portion dimension is greater than the maximum, proximal portion dimension.

10. The drink stirring device of claim 9, wherein the elongated member includes a textured surface adjacent to an upper end.

11. The drink stirring device of claim 10, wherein the textured surface comprises at least one of: a roughened surface and a knurled surface.

12. The drink stirring device of claim 9, wherein each of the at least one pair of mixing blade segments defines an opening within the mixing blade segment.

13. The drink stirring device of claim 9, wherein the at least one pair of mixing blade segments comprises a first pair of mixing blade segments extending in a first plane and a second pair of mixing blade segments extending in a second plane, wherein the first plane is perpendicular to the second plane.

14. The drink stirring device of claim 9, wherein the at least one pair of mixing blade segments further comprises a third pair of mixing blade segments extending in the first plane.

15. The drink stirring device of claim 9, wherein the elongated body and the at least one pair of mixing blade segments comprise a single, continuous, integrally formed article.

16. The drink stirring device of claim 9, wherein the elongated body defines at least one through-hole extending through the elongated body,
wherein each pair of mixing blade segments extend through an associated through-hole.

17. The drink stirring device of claim 9, wherein each pair of mixing blade segments comprises: an extension segment and two mixing blades at opposing ends of the extension segment.
